(19) United States
(12) Patent Application Publication
(10) Pub. No.: US 2019/0002175 A1
(43) Pub. Date: Jan. 3, 2019

(54) INDIVIDUAL BOTTLE INDEXING CONTAINER

(71) Applicant: Rehrig Pacific Company, Los Angeles, CA (US)

(72) Inventors: Dane Gin Mun Kalinowski, Foothill Ranch, CA (US); Sydney Marie Ogawa-Garcia, Riverside, CA (US); Joseph E. Popovits, II, Costa Mesa, CA (US)

(21) Appl. No.: 16/023,212

(22) Filed: Jun. 29, 2018

Related U.S. Application Data
(60) Provisional application No. 62/527,008, filed on Jun. 29, 2017.

(51) Int. Cl. B65D 77/04; B65D 21/02; B65D 25/04; B65D 25/30; B65D 25/56; G06M 1/27

(52) U.S. Cl. CPC B65D 77/0446; B65D 21/0215; B65D 25/04; B65D 2577/043; B65D 25/56; G06M 1/27; B65D 25/30

(57) ABSTRACT

An indexing container for beverage containers includes a base wall and a pair of side walls extending upward from the base wall to partially define a storage portion. A counter determines a number of beverage containers stored in the indexing container. A display indicates the number of beverage containers stored in the indexing container.

### BACKGROUND

On delivery routes such as vending machine delivery, the driver may need to deliver a specific number of an individual bottle or can size and flavor to the machine. In most cases, the number of bottles or cans to be delivered will be less than the total number of bottles in the case (such as a plastic shell or one-way packaging). This presents an issue during delivery in that partial cases are unstable when stacked and do not protect the product. Additionally, at the end of the delivery route, the driver is required to count the number of individual bottles in each flavor thus causing more work.

### SUMMARY

The indexing containers disclosed herein provide a secure method of packaging individual beverage containers for delivery and transportation. While the beverage containers are either loaded or removed from the indexing container the indexing container keeps count of the inventory maintained within. In addition to safely securing the individual beverage containers and maintaining the count, the indexing containers can be easily stacked on one another for ease and safe transportation in the delivery vehicle and from the vehicle to delivery location (i.e. racks, shelving, vending machine, etc.)

### BRIEF DESCRIPTION OF THE DRAWINGS

FIG. 1 is a perspective view of an indexing container according to a first embodiment, with a beverage container therein.

FIG. 2 is a front view of the indexing container and beverage container of FIG. 1.

FIG. 3 is a top view of the indexing container and beverage container of FIG. 1, with the upper wall removed.

FIG. 4 is a perspective view of the indexing container of FIG. 1, with the upper wall removed and two beverage containers stored therein

FIG. 5 is a front view of the indexing container and beverage containers of FIG. 4.

FIG. 6 is another perspective view of the indexing container and two beverage containers of FIG. 4.

FIG. 7 is a top view of the indexing container and two beverage containers of FIG. 4.

FIG. 8 is a perspective view of an indexing container according to a second embodiment

FIG. 9 is a top view of the indexing container of FIG. 8 with a beverage container received therein.

FIG. 10 is a perspective view of an indexing container according to a second embodiment, with beverage containers therein.

FIG. 11 is an enlarged view of a front portion of the indexing container and beverage containers of FIG. 10.

FIG. 12 is a bottom perspective view of the indexing container of FIG. 10.

FIG. 13 is a front view of the indexing container and beverage containers of FIG. 10.

FIG. 14 shows the indexing container of FIG. 10, partially broken away.

FIG. 15 shows the indexing container of FIG. 14 with a beverage container stored therein.

FIG. 16 shows the indexing container of FIG. 14 with two beverage containers stored therein.

FIG. 17 is a top view of the indexing container of FIG. 10, with the upper wall removed.

FIG. 18 shows the indexing container of FIG. 10 stacked on an identical indexing container.

FIG. 19 is an enlarged view of a front portion of a fourth embodiment of a indexing container with a visual counter.

FIG. 20 is a perspective view of an indexing container according to a fourth embodiment, with beverage containers therein.

FIG. 21 shows the indexing container and beverage containers of FIG. 20 with one of the chutes removed for illustration.

FIG. 22 shows the indexing container of FIG. 20, partially broken away.

FIG. 23 is a front view of the indexing container of FIG. 20.

FIG. 24 shows the indexing container of FIG. 20 stacked on an identical indexing container.

### DETAILED DESCRIPTION

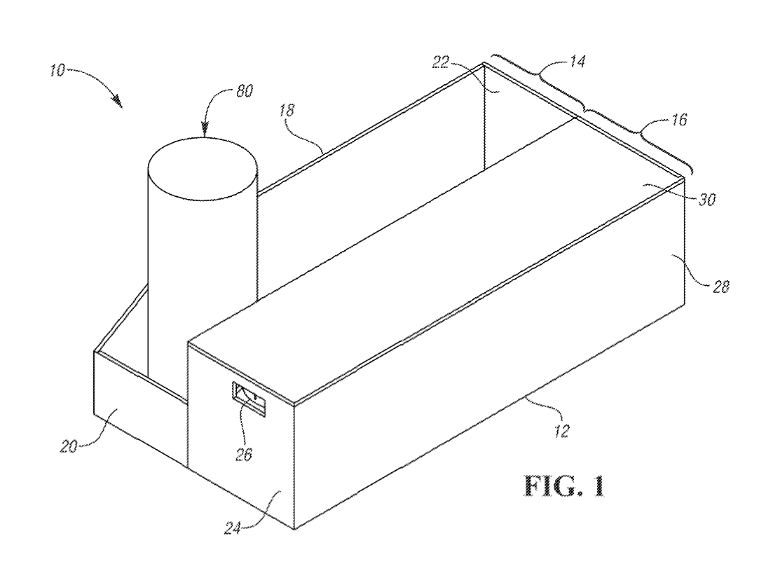

An indexing container 10 according to a first embodiment is shown in FIG. 1 with a single-serving beverage container 80 received therein. The beverage container 80, shown as a cylinder, could be a bottle or can. The indexing container 10 includes a base 12, a storage portion 14 and an indexing portion 16. The storage portion 14 in this example can accommodate six beverage containers 80, but other numbers of beverage containers 80 could be stored as well. The storage portion 14 includes a side wall 18, a short front wall 20, and a rear wall 22 opposite the front wall 20. The indexing portion 16 includes a front wall 24 and a side wall 28. The indexing portion 16 may also include an upper wall 30. A counter 26 is displayed through an opening through the front wall 24.

The indexing container 10 may further include an outer housing (not shown) that completely encloses the storage portion 14, indexing portion 16 and any beverage containers 80 in the storage portion 14. This would give the indexing container 10 a constant height, whether empty or full, so that other indexing containers 10 could be stacked thereon.

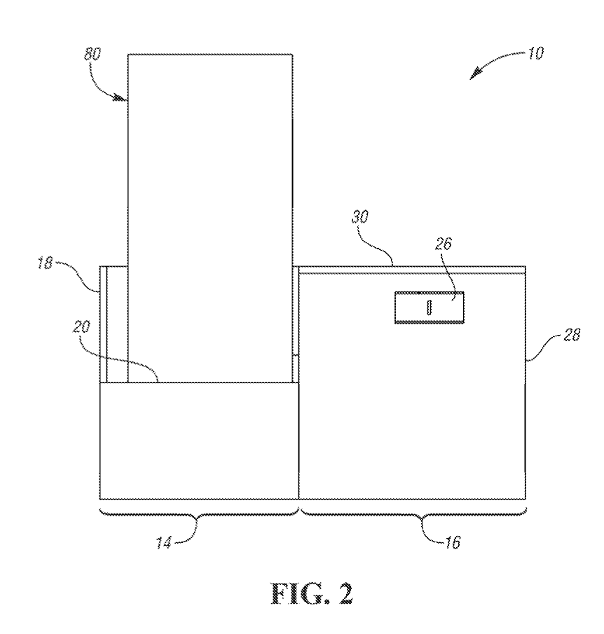

FIG. 2 is a front view of the indexing container 10. The beverage container 80 is in the storage portion 14 behind the short front wall 20. The counter 26 indicates that there is one beverage container 10 in the indexing container 10.

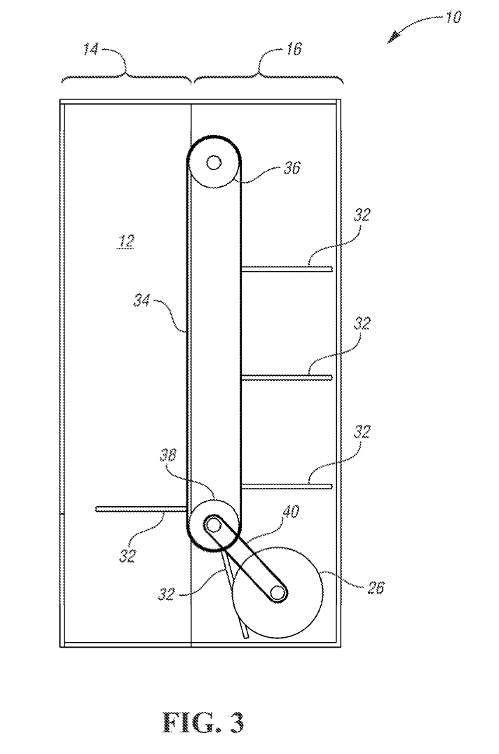

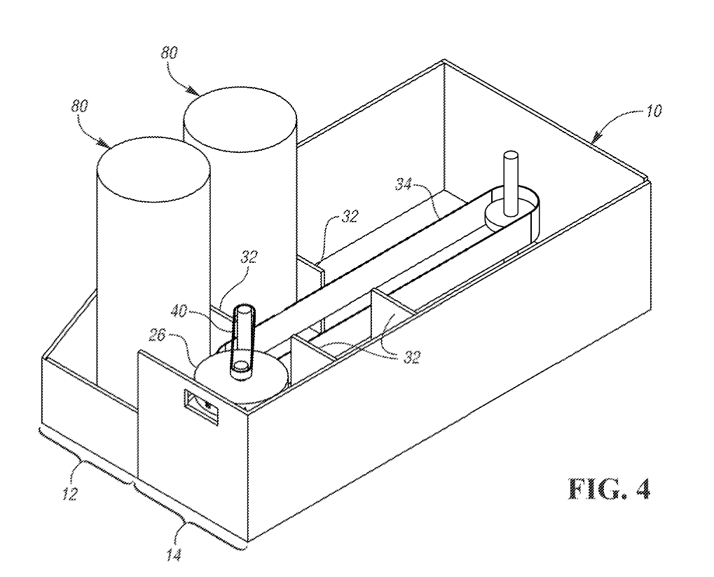

FIG. 3 is a top view of the indexing container 10 with upper wall 30 removed. FIG. 4 is a perspective view of the same with two beverage containers therein. As shown, the indexing portion 16 includes a plurality of paddles 32 (in this example, six), each projecting outward from a belt (or chain) 34 looped around two pulleys 36, 38. One of the pulleys 38 is connected via a belt 40 (or alternatively, gears) to drive the counter 26. The belt 34 and paddles 32 can move around the pulleys 36, 38 from the indexing portion 16 to the storage portion 14, from the front of the indexing container 10 to the rear of the indexing container 10.

As each successive beverage container 80 (FIG. 2) is inserted into the storage portion 14, the next paddle 32 is moved rearward along the storage portion 14. This causes rotation of the pulley 38, which then drives rotation of the counter 26. The pulleys and counter 26 are sized to ensure that as each beverage container 80 is inserted, the counter increments by one count. Alternatively, an electronic counter could increment upon sufficient rotation.

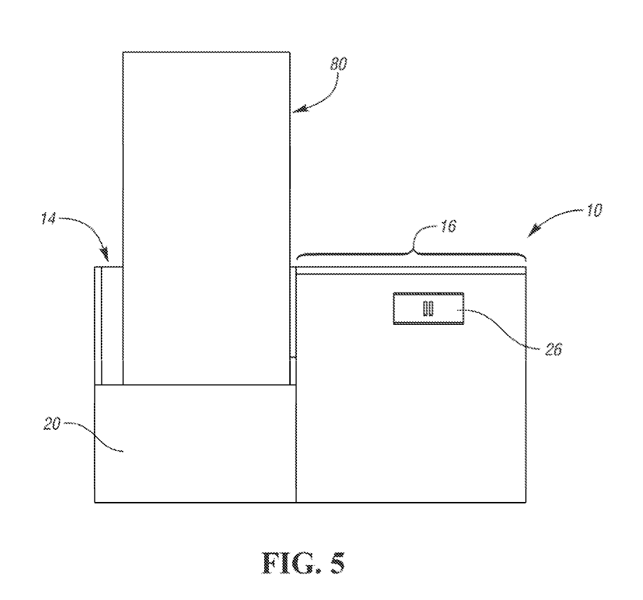

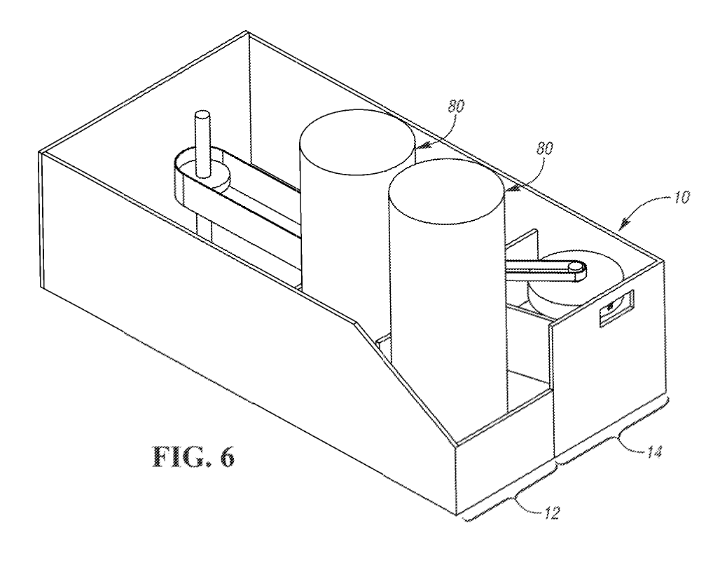

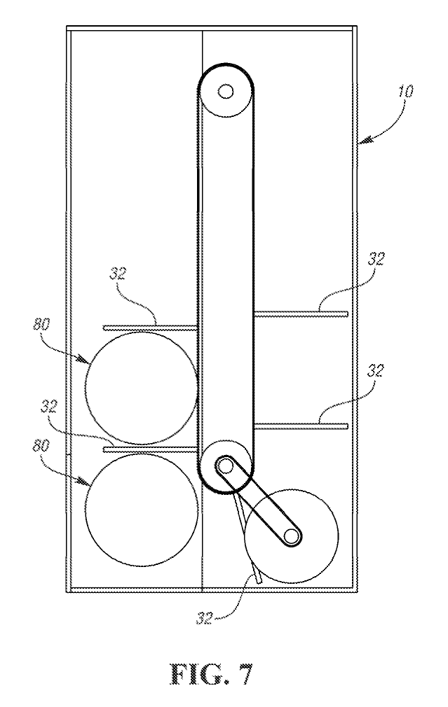

For example, FIG. 5 shows the indexing container 10 with two beverage containers 80 received therein. The counter 26 indicates “II,” as shown in FIG. 5, which is a front view of the indexing container 10 and two beverage containers 80 of FIG. 4. FIG. 6 is another perspective view of the indexing container 10 and two beverage containers 80 of FIG. 4. FIG. 7 is a top view of the indexing container 10 and two beverage containers 80 of FIG. 4.

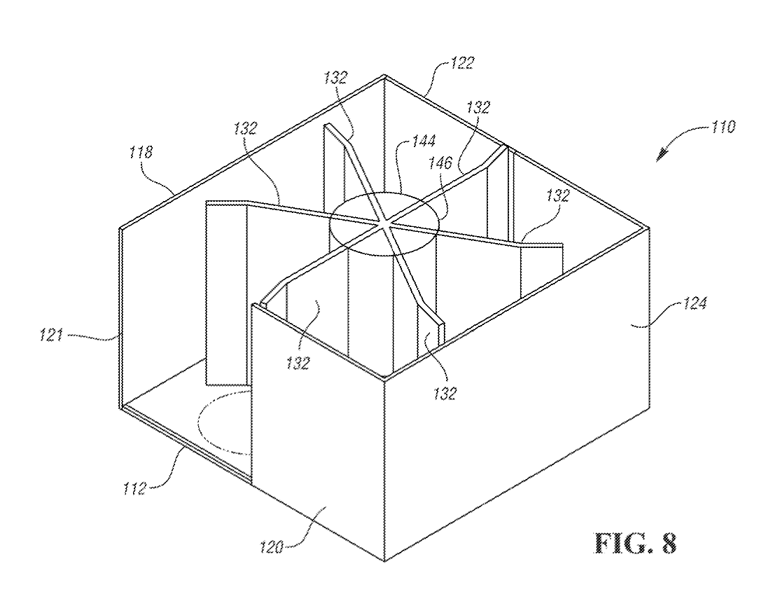

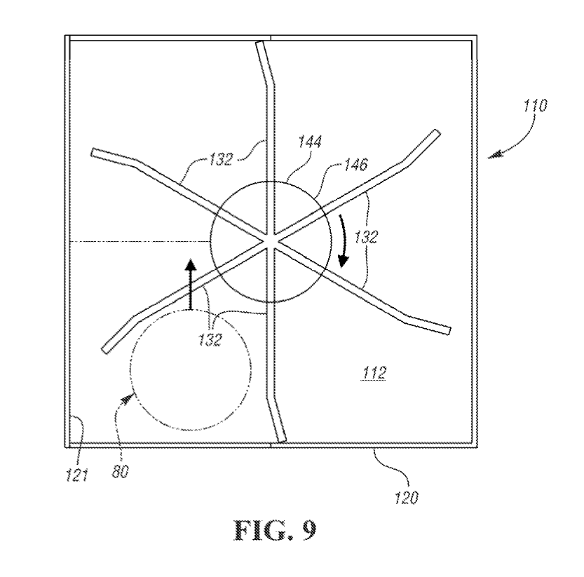

FIGS. 8 and 9 illustrate an indexing container 110 according to a second embodiment. The indexing container 110 includes a base 112, side walls 118, 124 and rear wall 122. Front wall 120 only covers about half of the front of indexing container 110, leaving front opening 121. The indexing portion 144 includes a rotatably mounted cylinder 146 having paddles 132 protruding radially therefrom.

Referring to FIG. 9, as beverage containers 80 are inserted through the front opening 121, they engage the next paddle 132 and cause another increment of rotation of the indexing portion 144. The rotation of the cylinder 144 causes a counter (not shown) to increment, such as the pulley/belt system of the first embodiment or an electronic counter that increments upon sufficient rotation of the indexing portion 144.

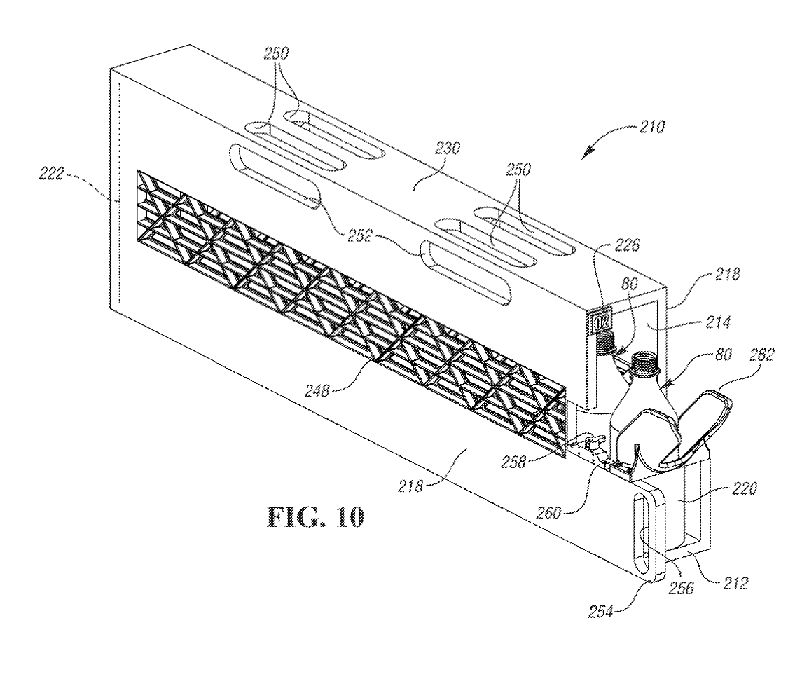

FIG. 10 shows an indexing container 210 according to a third embodiment with a single-serving beverage container 80 received therein. The indexing container 210 includes a base 212 supporting a storage portion 214. The storage portion 214 includes opposite side walls 218, a short front wall 220, and an optional rear wall 222 opposite the front wall 220. An upper wall 230 encloses the top of the container 210. A counter 226, such as an LED display or other electronic display, is mounted to the front of the container 210.

The side walls 218 may include grate openings 248 for reduced weight, ventilation and visibility into the container 210. Handle openings 250 are formed through the upper wall 230. Upper portions of the side walls 218 have handle openings 252 formed therethrough.

A forward wall 254 projects forward contiguously with one of the side walls 218 forward of the front wall 220. A handle opening 256 is formed through the forward wall 254.

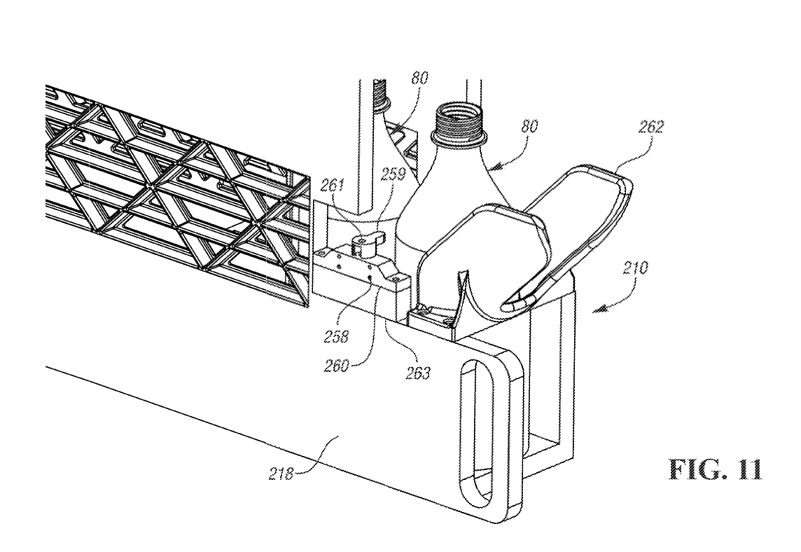

A chute 262 is mounted to the top of the front wall 220 to assist in placing beverage containers 80 into the indexing container 210. A counter 260 is mounted to one of the side walls 218. The counter 260 includes a pivoting paddle 258 that pivots rearward as each beverage container 80 is added to the indexing container 210 and pivots forward as each beverage container 80 is removed. FIG. 11 is an enlarged view of the front portion of the indexing container 210. The pivoting paddle 258 includes a finger 259 projecting inward toward the beverage containers 80. The pivoting paddle 258 pivots on an axis 261. The counter 260 counts each forward pivot and each rearward pivot to keep a current count of the number of beverage containers 80 in the indexing container 210 and to cause the current count of beverage containers 80 to be displayed on the display 226. A communications module 263 may transmit the count wirelessly to the display 226 and/or to a remote computer or handheld device, such as a smartphone or tablet (via, e.g. NFC, RFID, Bluetooth, WIFI, 3G/4G and/or may provide a port for wired communication). Any electronics in this disclosure could be powered by a battery and/or solar power, etc.

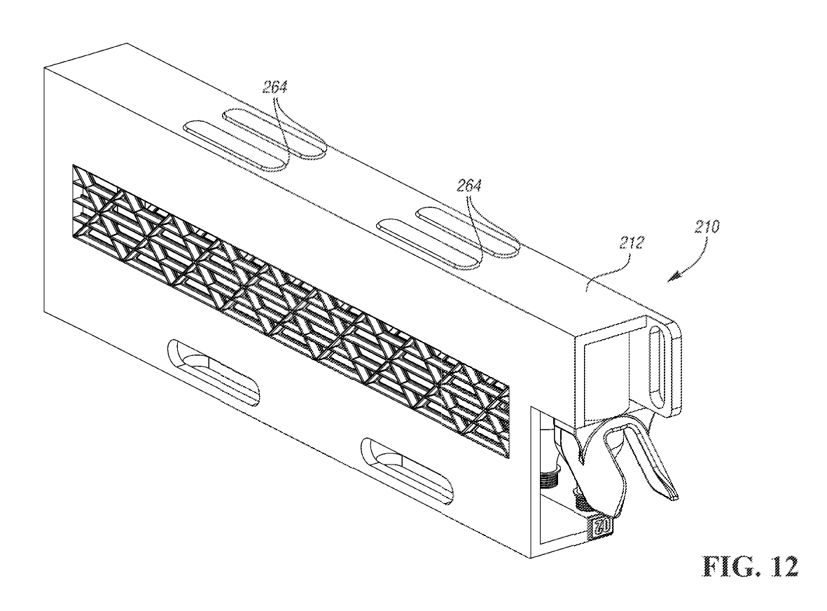

FIG. 12 is a bottom perspective view of the indexing container 210. The bottom surface of the base wall 212 includes a plurality of bosses 264 that are complementary to the handle openings 250 formed in the upper wall 230 (FIG. 10).

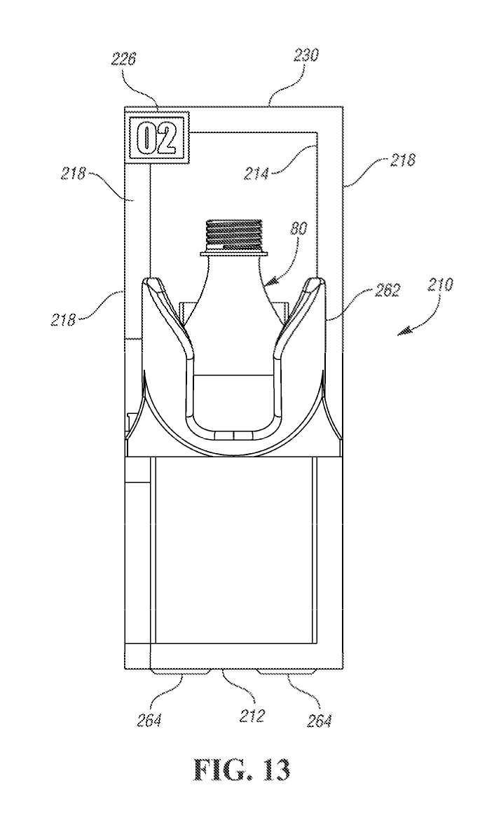

FIG. 13 is a front view of the indexing container 210. As shown, the bosses 264 project downward from the base 212.

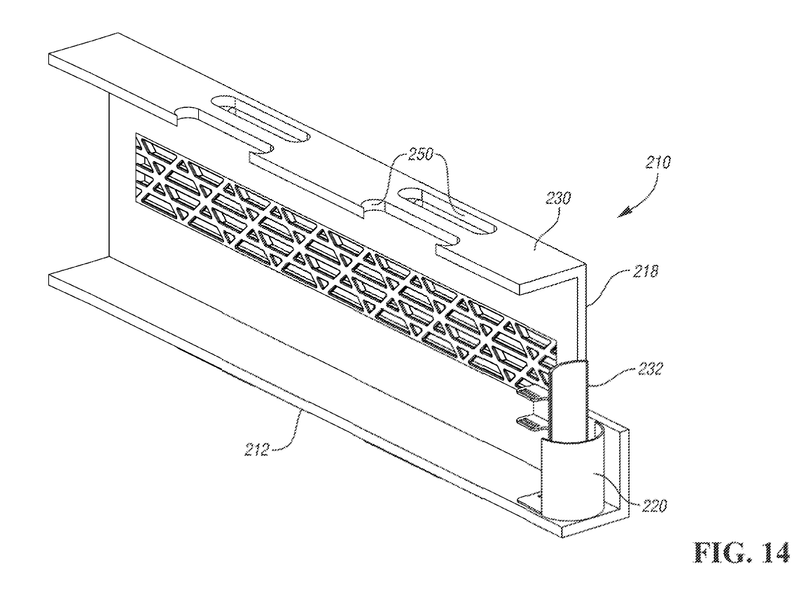

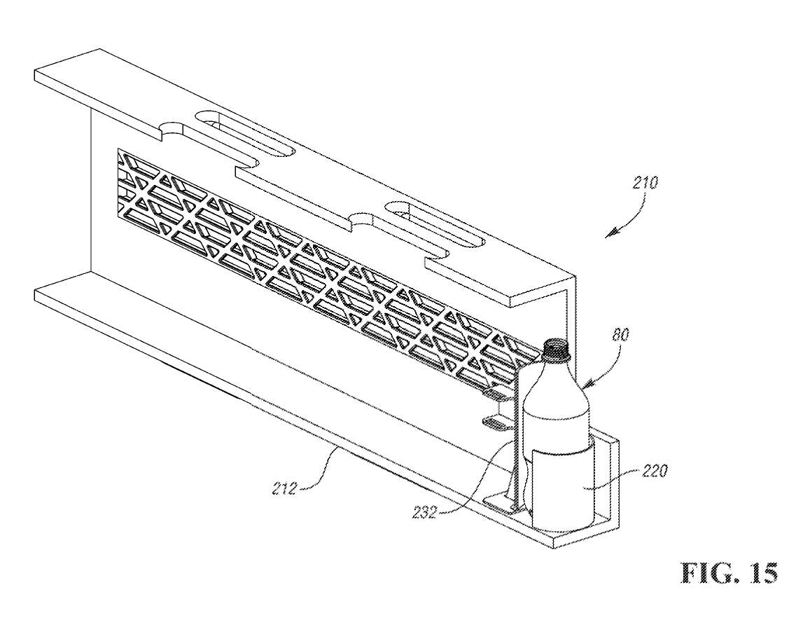

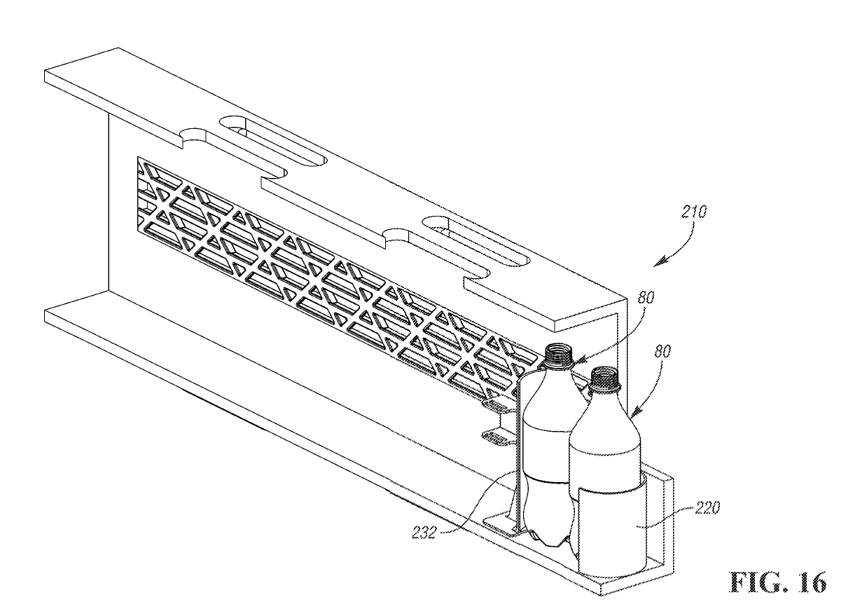

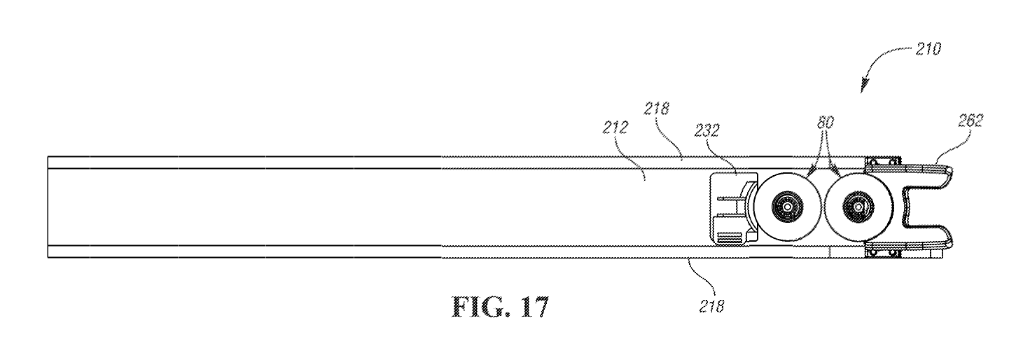

FIG. 14 is a perspective view of the indexing container 210, partially broken away to show the interior. A backrest or paddle 232 is biases toward the front wall 220. A spring (not shown) may bias the paddle 232 toward the front wall 220. Alternatively, the indexing container or the base 212 may be inclined toward the front wall 220 to keep the beverage containers pushed against the front wall 220. As shown in FIGS. 15-17, as beverage containers 80 are inserted between the front wall 220 and the paddle 232, the paddle 232 moves away from the front wall 220. As an alternative implementation, an encoder could be connected to the paddle 232 to measure the position of the paddle 232 relative to the front wall 220, calculate the number of beverage containers 80 in the indexing container 210 and cause the display 226 to display it.

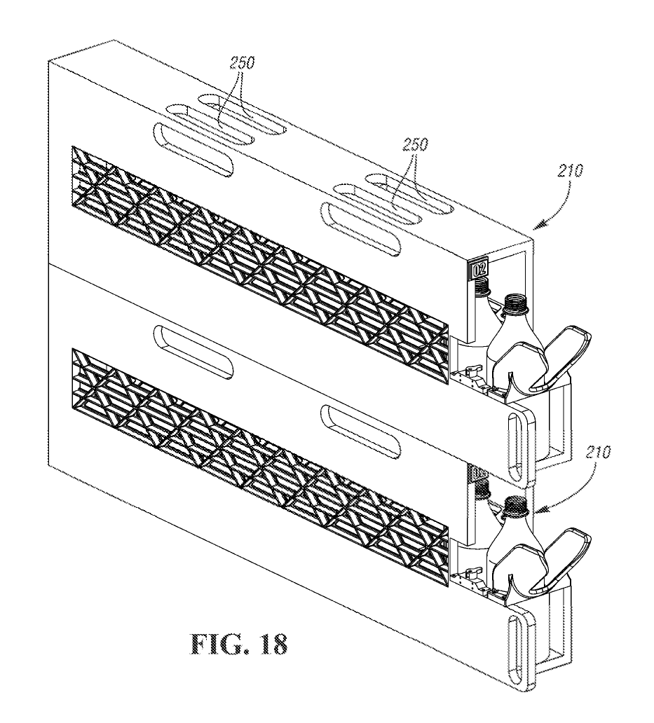

As shown in FIG. 18, the indexing container 210 can be stacked on an identical container 210. The bosses 264 (FIG. 12) of the upper container 210 are received in the handle openings 250 of the lower container 210 to improve the stability of the stack.

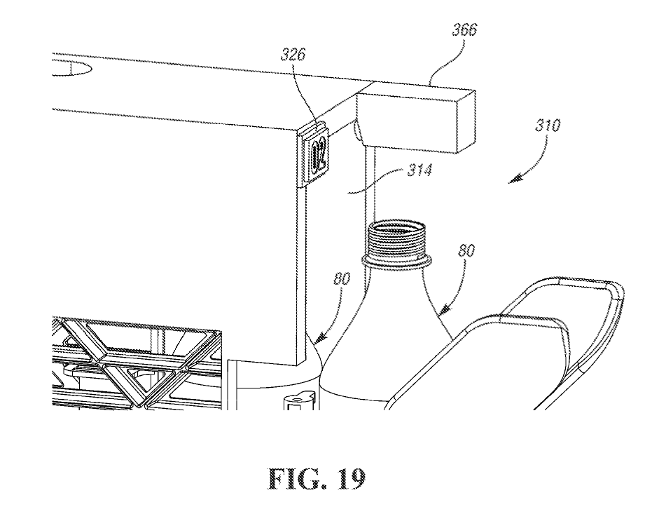

FIG. 19 is an enlarged view of a front of a fourth indexing container 310. The indexing container 310 is identical to the indexing container 210 except as shown and described. In this embodiment, a camera 366 is directed to the storage portion 314 of the indexing container 310. A microprocessor in the camera housing identifies the number of beverage containers 80 in the indexing container 310 based upon the image. The camera 366 may provide static or live video feeds to a remote system (such as a server, laptop, desktop, smartphone, tablet, etc). The remote system could be used for optical recognition or simply visual verification of what product, size and count is currently in the indexing container 310 and to store historical and real time data. The data can be then used by the driver, warehouse or Operations to provide additional analytics to improve the delivery process.

Independent of the counter technology used in any of the above embodiments, the data can be transferred through any means for additional analysis. Examples of communication types include a plug in wired system, NFC, RFID, Bluetooth, WIFI, 3G/4G, etc. In addition to counting how many beverage containers are there, the counter could also read expiration dates, and identify flavors and/or sizes (e.g. using the camera 366) and provide a count for each expiration date/flavor/size permutation. The data including flavor, size, count, expiration, etc. can then be transferred to a nearby device or to a central server for further data analytics and metrics. The data can be used for historical or real time analysis to improve operations.

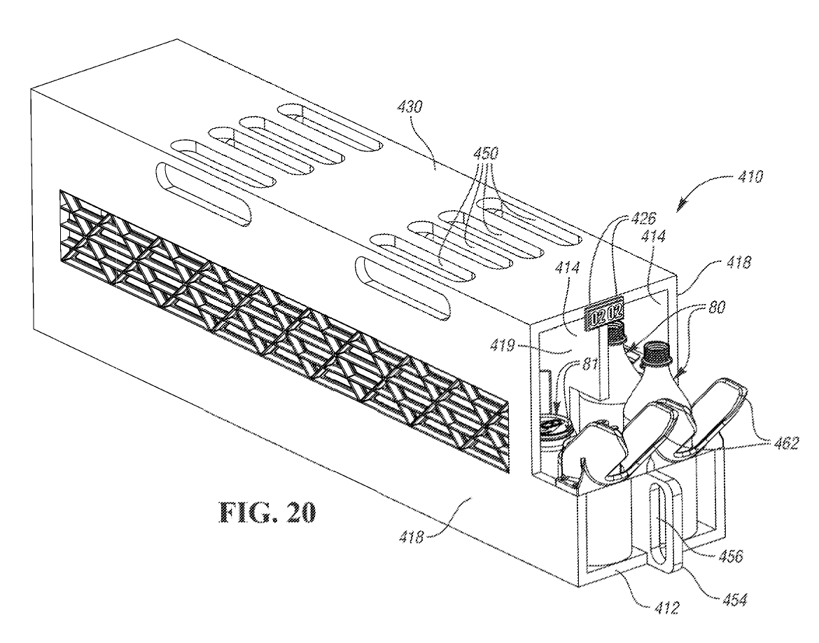

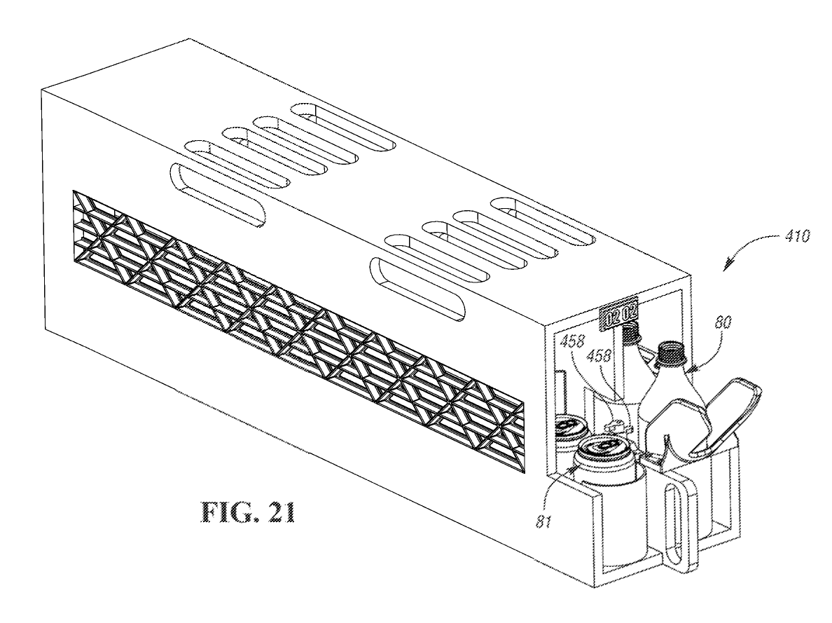

A fifth embodiment of an indexing container 410 is shown in FIG. 20. The indexing container 410 is identical to the indexing container 210 or indexing container 310, except as may be described below or shown in the drawings. In this embodiment, two separate storage portions 414 are provided, each with a separate counting paddle 458 (FIG. 21) and a separate display 426. An interior wall 419 separates the two storage portions 414. A forward portion 454 of the interior wall 419 projects forward and has a handle opening 456 therethrough. Each storage portion 414 may be used to store a different flavor, brand, size or form of beverage container 80, 81. In the drawings, a bottle 80 vs a can 81 is shown, but in use the differences may be flavors or brands, so that a separate count of each is kept. Any of the counting and communication methods described above could be used, including as shown in FIG. 21, separate counting paddles 458 for each storage portion 414.

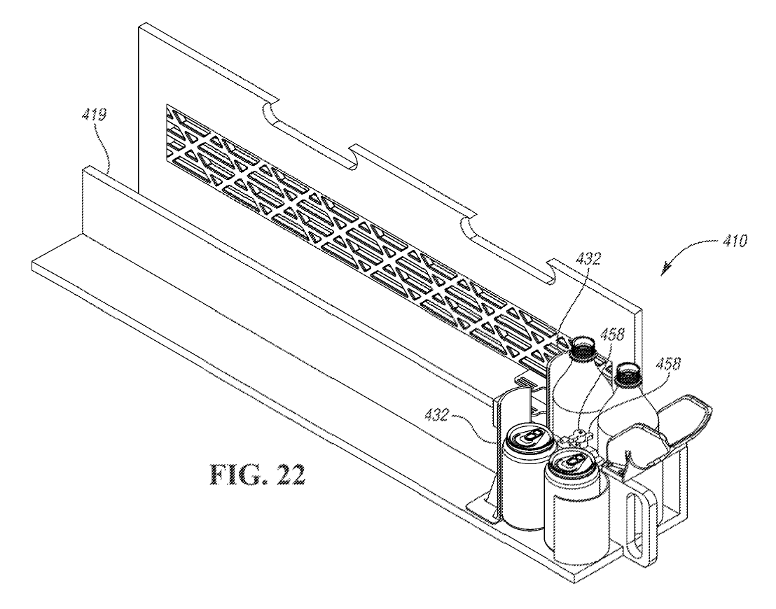

FIG. 22 is a cutaway view of the indexing container 410 of FIG. 20. The pair of indexing paddles 458 are mounted to the interior wall 419. A pair of paddles 432 operate independently of one another as each side is filled or emptied.

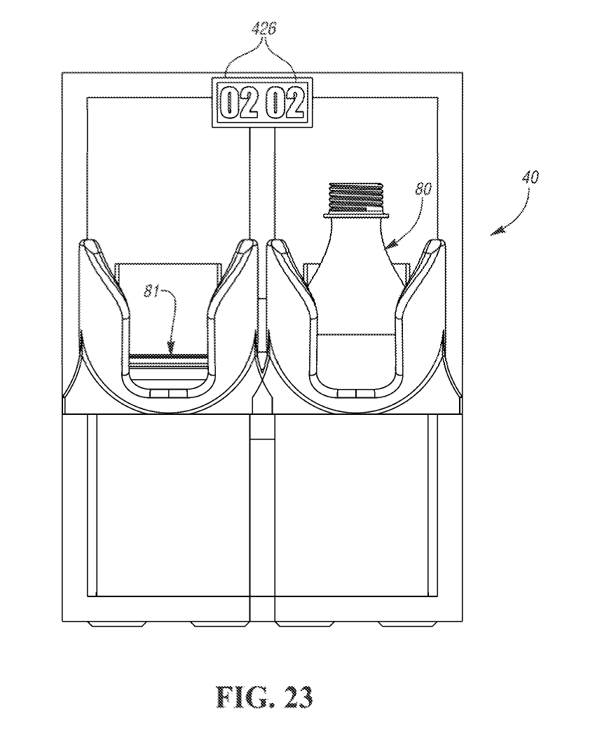

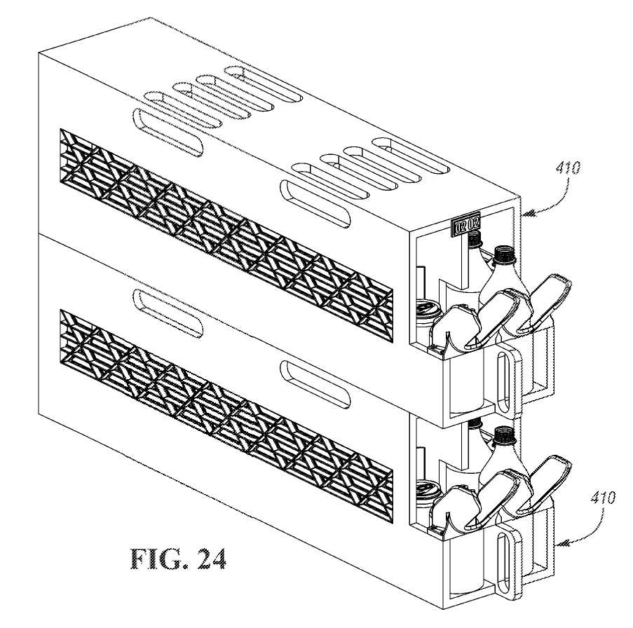

FIG. 23 is a front view of the indexing container 410. As shown in FIG. 24, the indexing containers 410 can be stacked on one another. Bosses (not shown) complementary to the upper handle openings improve the stability of the stack.

The indexing containers 10, 110, 210, 310, 410 are designed to be compatible with several bottle or can sizes. This allows the driver to select whatever flavor or size of beverage and load it into the indexing container on the fly during delivery.

The indexing containers 10, 110, 210, 310, 410 also include the counter (either mechanical or electronic). The counter displays an accurate count of the number of beverage containers 80 held within the container 10, 110, 210, 310, 410. This is especially helpful on vending machine delivery routes where it is common for the driver to have to load partial cases into machines. This also helps at the beginning and end of the route where the driver is required to take an accurate count of each flavor and size beverage container 80 on the truck.

The indexing containers 10, 110, 210, 310, 410 are compact and modular so the footprint can be optimized for any delivery transportation scenario. This could include transport in a side bay trailer, standard trailer, box truck, hand truck, or convertible hand truck to name a few. The indexing containers 10, 110, 210, 310, 410 can also be optimized to fit a specific bottle count if necessary.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope.

What is claimed is:

1. An indexing container for beverage containers comprising:
a base wall;
a pair of side walls extending upward from the base wall to partially define a storage portion;
a counter determining a number of beverage containers stored in the indexing container; and
a display indicating the number of beverage containers stored in the indexing container.

2. The indexing container of claim 1 further including at least one paddle moving away from an opening to the indexing container each time that a beverage container is added to the indexing container.

3. The indexing container of claim 2 wherein the paddle moves toward the opening to the indexing container each time that a beverage container is removed from the indexing container.

4. The indexing container of claim 1 further including a pivoting paddle pivoting in a first direction each time that a beverage container is added to the indexing container, the pivoting paddle pivoting in a second direction opposite the first direction each time that a beverage container is removed from the indexing container.

5. The indexing container of claim 1 further including wireless communication module wirelessly transmitting the number of beverage containers stored in the indexing container.

6. The indexing container of claim 1 further including an upper wall connected to an upper portion of the side walls, wherein a plurality of handle openings are formed through the upper wall.

7. The indexing container of claim 6 further including a plurality of bosses formed on an undersurface of the base wall, wherein the plurality of bosses are configured to be received in the plurality of handle openings formed through the upper wall of an identical container.

8. The indexing container of claim 1 further including a chute angling forward and upward from a front wall shorter than the side walls.

9. The indexing container of claim 1 further including a front wall shorter than the side walls and partially defining an opening into the indexing container through which beverage containers can be added to and removed from the indexing container.

10. The indexing container of claim 9 further including a forward wall extending forward of the front wall and having a handle opening therethrough.

11. The indexing container of claim 9 wherein the storage portion is a first storage portion partially defined by an interior wall separating the first storage portion from a second storage portion, wherein the opening defined by the front wall is a first opening to the first storage portion and wherein the counter is a first counter determining the number of beverage containers stored in the first storage portion, and wherein the display is a first display indicating the number of beverage containers stored in the first portion, the indexing container further including a second counter determining the number of beverage containers stored in the second storage portion, the indexing container further including a second display indicating the number of beverage container storage in the second storage portion.

12. The indexing container of claim 1 wherein the counter includes a camera directed toward an interior of the indexing container.

13. A container for beverage containers comprising:
a base wall;
a pair of side walls extending upward from the base wall to partially define a storage portion;
an upper wall connecting the pair of side walls; and
a plurality of handle openings formed through the upper wall.

14. The container of claim 13 further including a plurality of bosses formed on an undersurface of the base wall, wherein the plurality of bosses are configured to be received in the plurality of handle openings formed through the upper wall of an identical container.

15. The container of claim 13 further including a front wall shorter than the side walls and partially defining an opening into the container through which beverage containers can be added to and removed from the container.

16. The container of claim 15 further including a chute angling forward and upward from the front wall.

17. The container of claim 15 further including a forward wall extending forward of the front wall and having a handle opening therethrough.

18. The container of claim 15 further including at least one paddle configured to move away from an opening to the container each time that a beverage container is added to the indexing container through the opening.

19. The container of claim 18 wherein the paddle is configured to move toward the opening to the container each time that a beverage container is removed from the container through the opening.
